(19) United States
(12) Patent Application Publication
(10) Pub. No.: US 2007/0131887 A1
(43) Pub. Date: Jun. 14, 2007

(54) Solenoid valve with adjustable slow air discharging speed

(75) Inventor: T. C. Huang, Changhua County (TW)

Correspondence Address: BACON & THOMAS, PLLC, 625 SLATERS LANE, FOURTH FLOOR, ALEXANDRIA, VA, 22314, US

(73) Assignee: TRICORE CORPORATION, CHANG HUA (TW)

(21) Appl. No.: 11/636,988

(22) Filed: Dec. 12, 2006

(30) Foreign Application Priority Data
Dec. 14, 2005 (TW) 94221822

(51) Int. Cl. F16K 31/02

(52) U.S. Cl. 251/129.01

(57) ABSTRACT

A solenoid valve includes a holder, which holds a locating rod that defines an axial through hole for quick discharge of an air, a coil assembly, a magnetic actuating rod axially slidably mounted in the coil assembly, an exhaust valve mounted in the magnetic actuating rod and defining an exhaust hole, a control member for regulating the passage of the exhaust hole, a spring stopped between the actuating rod and the locating rod, and a seal provided at the front side of the magnetic actuating rod for stopping against the locating rod to block the axial through hole of the locating rod for exhaust of the air through the exhaust hole of the exhaust valve at a slow speed.

### BACKGROUND OF THE INVENTION

1. Field of the Invention

The present invention relates to solenoid valves and more particularly, to such a solenoid valve that provides an adjustable slow air discharging speed.

2. Description of the Related Art

Conventional solenoid valves for controlling discharging of an air commonly provide only one quick air discharging action, i.e., only a rapid air discharging speed. There are also solenoid valves that provide quick and slow air discharging speeds.

However, conventional solenoid valves do not allow the user to regulate the air discharging speed. Further, conventional solenoid valves commonly have a complicated structure. These complicated solenoid valves may not work accurately during operation. Further, these complicated solenoid valves are difficult to install and, not durable in use.

Therefore, it is desirable to provide a solenoid valve that eliminates the aforesaid drawbacks.

### SUMMARY OF THE INVENTION

The present invention has been accomplished under the circumstances in view. It is one object of the present invention to provide a simple structure of solenoid valve, which provides a quick air discharging speed and a slow air discharging speed, and allows the user to adjust the flow rate when at the slow air discharging speed mode.

It is another object of the present invention to provide a simple structure of solenoid valve, which works accurately and positively.

It is still another object of the present invention to provide a simple structure of solenoid valve, which is easy to install and durable in use.

To achieve these and other objects of the present invention, the solenoid valve comprises a holder, the holder comprising a yoke frame, a receiving space defined in the yoke frame, a locating rod fixedly mounted in a side panel of the yoke frame, an axial through hole axially extending through two distal ends of the locating rod; a coil assembly, the coil assembly comprising a bobbin, the bobbin defining therein an axially extending sliding hole, and a coil wound round the bobbin; a magnetic actuating set, the magnetic actuating set comprising an actuating rod axially slidably mounted in the axially extending sliding hole of the bobbin and movable by a magnetic force toward the locating rod when the coil of the coil assembly is electrically energized, an exhaust valve mounted in the actuating rod for controlling discharge of an air through the axial through hole of the locating rod, and a control member for controlling the flow rate of the air passing through the exhaust valve; spring means stopped between the magnetic actuating set and the locating rod; and seal means provided at one end of the actuating rod and adapted to seal the axial through hole of the locating rod.

### BRIEF DESCRIPTION OF THE DRAWINGS

FIG. 1 is an exploded view of a solenoid valve according to the present invention.

FIG. 2 is an elevational assembly view of the solenoid valve shown in FIG. 1.

FIG. 3 is a sectional front view in an enlarged scale of the solenoid valve shown in FIG. 2.

FIG. 4 is similar to FIG. 3 but showing the actuating set stopped against the locating rod.

FIG. 5 is an exploded view of the actuating set in an enlarged scale of the solenoid valve shown in FIG. 1.

FIG. 6 is a sectional side view of the actuating set shown in FIG. 5.

FIG. 7 is a sectional assembly view of the actuating set shown in FIG. 5.

FIG. 8 is an exploded view of an alternate form of the actuating set according to the present invention.

FIG. 9 is a sectional assembly view in an enlarged scale of the actuating set shown in FIG. 8.

FIG. 10 is a sectional assembly view of another alternate form of the actuating set according to the present invention.

FIG. 11 is a sectional view taken along line 11-11 of FIG. 10.

FIG. 12 is a sectional assembly view of still another alternate form of the actuating set according to the present invention.

FIG. 13 is a sectional view taken along line 13-13 of FIG. 11.

### DETAILED DESCRIPTION OF THE INVENTION

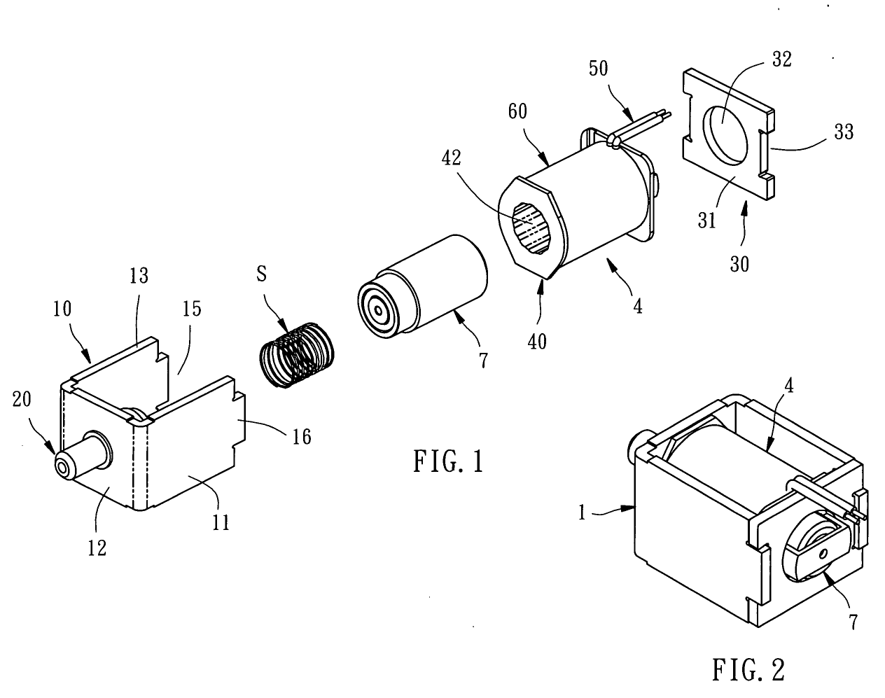

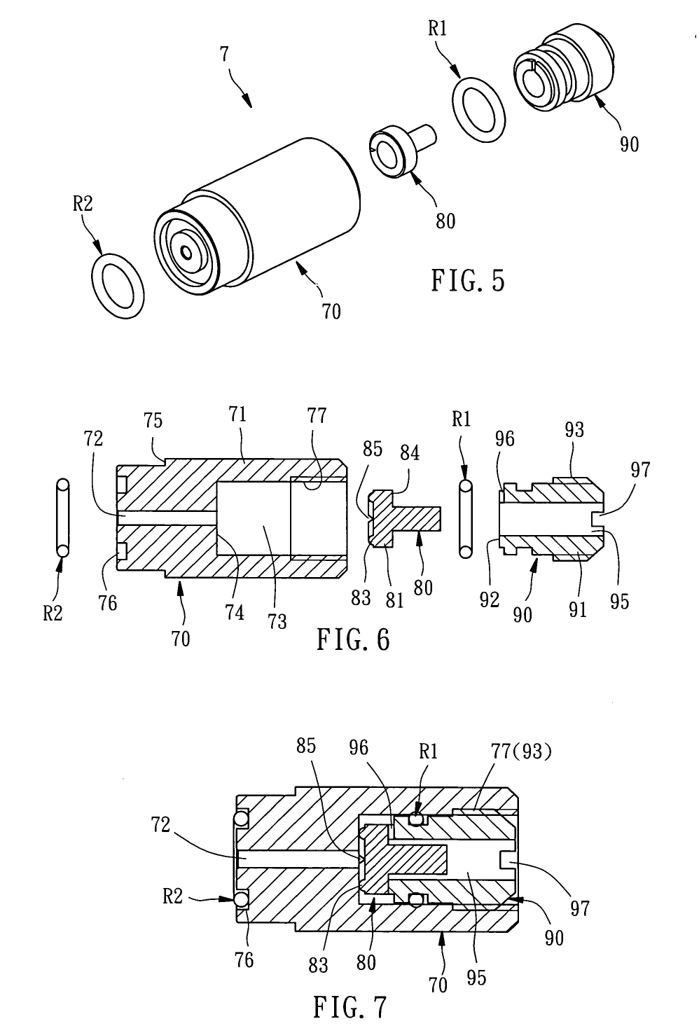

Referring to FIGS. 1-7, a solenoid valve in accordance with one embodiment of the present invention is shown comprising a holder 1, a coil assembly 4, an actuating set 7, a first seal ring R1, a second seal ring R2, and a compression spring S.

The holder 1 is comprised of a yoke frame 10, a locating rod 20, and a cover plate 30. The yoke frame 10 is a metal frame having a bottom panel 11, a top panel 13, and a side panel 12 connected between the bottom panel 11 and the top panel 13 at one side. The bottom panel 11, the top panel 13 and the side panel 12 surround a receiving space 15. Further, the bottom panel 11 and the top panel 13 each have a protruding locating block 16 at one end remote from the side panel 12. The locating rod 20 is mounted in the side panel 12 of the yoke frame 10, having a first rod section 21 disposed outside the yoke frame 11, a second rod section 22 connected to one end of the first rod section 21 and suspending in the receiving space 15, a bearing portion 23 formed integral with one end of the second rod section 22 remote from the first rod section 21 for supporting the compression spring S, a stop edge 25 at one end of the bearing portion 23 remote from the second rod section 22, and an axial through hole 27 axially extending through the two distal ends thereof. The cover plate 30 has a body 31, a center opening 32 cut through the center of the body 31, and two mounting notches 33 disposed on two opposite lateral sides of the body 31 and respectively coupled to the locating blocks 16.

The coil assembly 4 comprises a bobbin 40, a coil 50, and an electrically insulative film 60. The bobbin 40 has a hollow cylindrical body 41 defining a sliding hole 42 that cuts through the two distal ends of the cylindrical body 41, and a flange 44 extending from the rear end. The coil 50 is formed of a copper wire 51 and wound round the hollow cylindrical body 41 of the bobbin 40, having two lead-out ends 53. The electrically insulative film 60 is wrapped about the coil 50.

The actuating set 7 is comprised of an actuating rod 70, a discharging valve 80, and a control member 90. The actuating rod 70 is made of a magnetic material, comprising a body 71 axially slidably mounted in the sliding hole 42 inside coil assembly 4. The body 71 has an exhaust hole 72 axially forwardly extending to the front side thereof, a mounting hole 73 axially backwardly extending to the rear side thereof in air communication with the exhaust hole 72, an inside stop wall 74 extending around the connection section between the exhaust hole 72 and the mounting hole 73, a bearing portion 75 provided around the periphery thereof for bearing the compression spring S, a locating groove 76 formed on the front side around the exhaust hole 72, and an inner thread 77 formed on the rear side inside the mounting hole 73.

The exhaust valve 80 comprises a valve body 81 mounted in the mounting hole 73 of the actuating rod 70. The valve body 81 has an annular stop flange 83 for stopping against the inside stop wall 74 of the actuating rod 70 to block the exhaust hole 72, a bearing wall 84 opposite to the annular stop flange 83, and an adjustable air discharging hole 85 on the annular stop flange 83. According to this embodiment, the adjustable air discharging hole 85 is a V-notch.

The control member 90 has a body 91. The body 91 has a front squeeze portion 92, an outer thread 93 extending around the periphery and threaded into the inner thread 77 of the actuating rod 70, an adjustment hole 95, an air passage 96 in communication with the adjustment hole 95, and a control portion 97.

The first seal ring R1 is a rubber O-ring mounted on the body 91 of the control member 90 to seal the gap between the inside wall of the mounting hole 73 of the actuating rod 70 and the outside wall of the body 91 of the control member 90.

The second seal ring R2 is a rubber O-ring mounted in the annular locating groove 76 of the actuating rod 70 and stopped against the bearing portion 23 of the locating rod 20.

The compression spring S is supported between the bearing portion 23 of the locating rod 20 and the bearing portion 75 of the actuating rod 70.

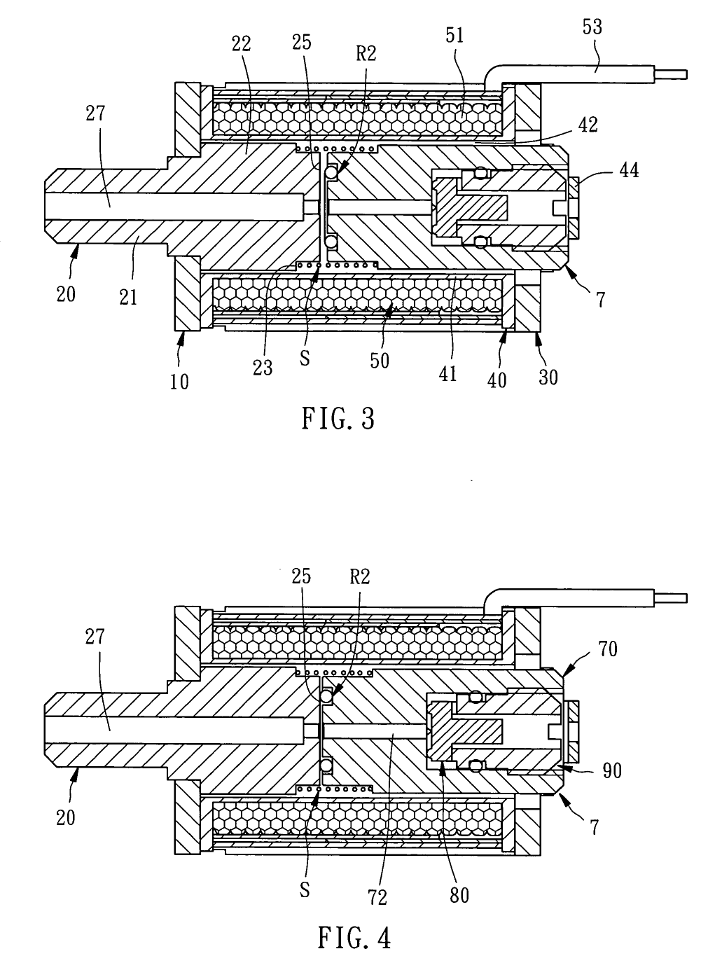

The operation of the solenoid valve is outlined hereinafter. As shown in FIG. 3, before connection of electric current to the coil 50, the actuating set 7 does no work, and the compression spring S pushes the actuating set 7 away from the locating rod 20, keeping the actuating set 7 stopped against the flange 44 of the bobbin 40 and the second seal ring R2 with the actuating rod 70 spaced from the stop edge 25 of the locating rod 20 at a distance for quick discharging of the air (not shown) through the axial through hole 27.

On the contrary, as shown in FIG. 4, when the coil 50 is electrically energized to produce a magnetic force, the actuating set 7 is forced by the magnetic force to overcome the spring force of the compression spring S and to move toward the locating rod 20, thereby stopping with the second seal ring R2 against the stop edge 25 of the locating rod 20, for enabling the air to discharging through the adjustable air discharging hole 85 (V-notch) of the exhaust valve 80 and then the adjustment hole 95 of the control member 90.

The main feature of the present invention is that the control member 90 is rotatable to compress the front squeeze portion 92 against the bearing wall 84 of the exhaust valve 80 and squeeze against said exhaust valve axially, thereby adjusting the opening of the V-notch 85 of the exhaust valve 80, i.e., adjusting the flow rate of the exhaust air through the adjustable air discharging hole 85 (V-notch) of the exhaust valve 80 and the adjustment hole 95 of the control member 90.

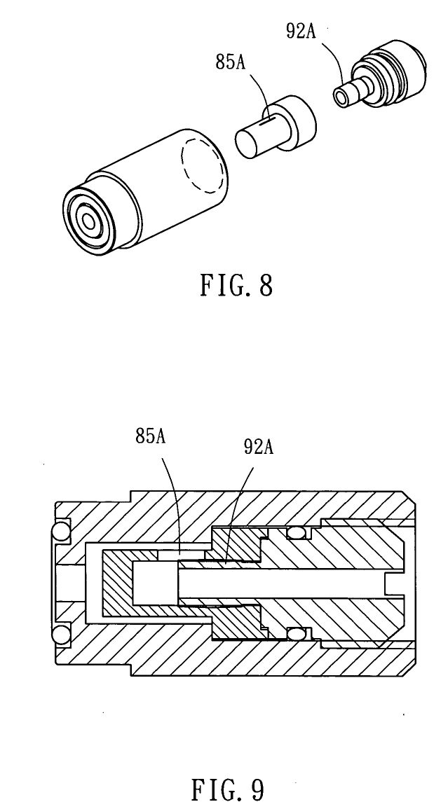

FIGS. 8 and 9 show an alternate form of the present invention. According to this embodiment, the adjustable air discharging hole 85A is a transverse through slit on the exhaust valve, and the front squeeze portion 92A of the control member is a rod member inserted into the exhaust valve and axially movable with the control member relative to the exhaust valve and squeeze against said exhaust valve radially to adjust the opening of the adjustable air discharging hole 85A.

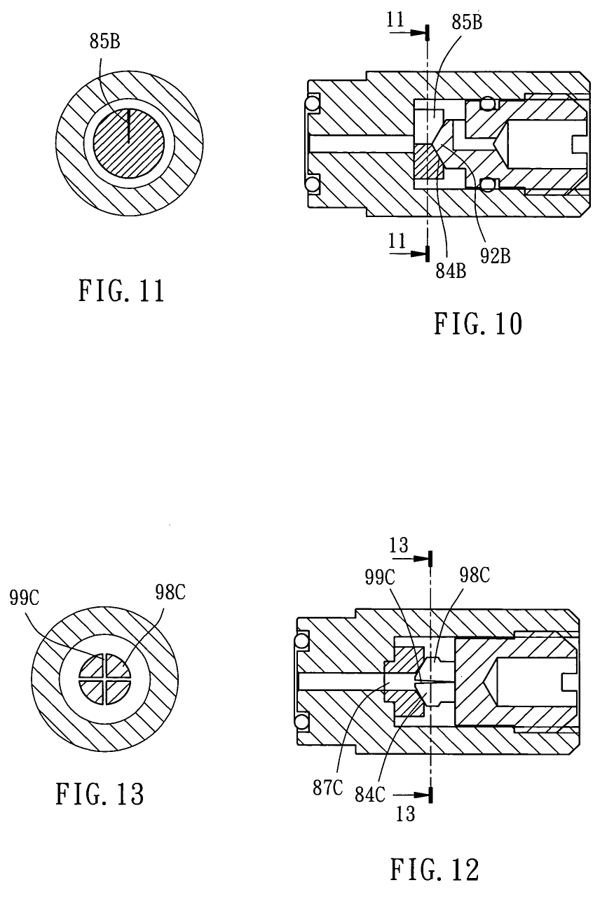

FIGS. 10 and 11 show another alternate form of the present invention. According to this embodiment, the bearing wall 84B of the exhaust valve curves smoothly inwards, the adjustable air discharging hole 85B is a transverse through hole on the exhaust valve, and the front squeeze portion 92B of the control member is tapered and fitting the inwardly curved bearing wall 84B and axially movable with the control member relative to the exhaust valve to adjust the opening of the adjustable air discharging hole 85B.

FIGS. 12 and 13 show still another alternate form of the present invention. According to this embodiment, the bearing wall 84C of the exhaust valve curves smoothly inwards and has a center through hole 87C is air communication with the exhaust hole of the actuating rod, and the front squeeze portion 98C of the control member is a split member having a plurality of crevices 99C in air communication with the center through hole 87C. Adjusting the position of the control member relative to the actuating rod relatively changes the pressure of the front squeeze portion 98C of the control member against the bearing wall 84C of the exhaust valve, and therefore the opening of the crevices 99C is relatively adjusted, i.e., the flow rate of the discharging air at the slow speed is relatively regulated.

As indicated above, the invention provides a solenoid valve, which has the benefits as follows:

1. The solenoid valve has a simple structure that allows the user to adjust the flow rate of the slow air discharging speed.

2. The solenoid valve is easy to install and durable in use, and works accurately and positively.

What is claimed is:

1. A solenoid valve comprising:
a holder, said holder comprising a yoke frame, a receiving space defined in said yoke frame, a locating rod fixedly mounted in a side panel of said yoke frame, an axial through hole axially extending through two distal ends of said locating rod;
a coil assembly, said coil assembly comprising a bobbin, said bobbin defining therein an axially extending sliding hole, and a coil wound round said bobbin;
a magnetic actuating set, said magnetic actuating set comprising an actuating rod axially slidably mounted in said axially extending sliding hole of said bobbin and movable by a magnetic force toward said locating rod when said coil of said coil assembly is electrically energized, an exhaust valve mounted in said actuating rod for controlling discharge of an air through the axial through hole of said locating rod, and a control member for controlling the flow rate of the air passing through said exhaust valve;
spring means stopped between said magnetic actuating set and said locating rod of said holder; and
seal means provided at one end of said actuating rod and adapted to seal said axial through hole of said locating rod.

2. The solenoid valve as claimed in claim 1, wherein said exhaust valve of said actuating set has an adjustable air discharging hole in air communication with the axial through hole of said locating rod of said holder.

3. The solenoid valve as claimed in claim 2, wherein the adjustable air discharging hole of said exhaust valve is a V-notch on a front annular stop flange thereof.

4. The solenoid valve as claimed in claim 2, wherein the adjustable air discharging hole of said exhaust valve is a transverse through slit.

5. The solenoid valve as claimed in claim 2, wherein said control member of said actuating set is axially movable relative to said exhaust valve and squeeze against said exhaust valve axially or radially to adjust the opening of the adjustable air discharging hole of said exhaust valve.

6. The solenoid valve as claimed in claim 1, wherein said control member of said actuating set has an adjustable air discharging hole.

7. The solenoid valve as claimed in claim 6, wherein said control member of said actuating set has a front squeeze portion, said front squeeze portion having a plurality of crevices that form said adjustable air discharging hole.

8. The solenoid valve as claimed in claim 6, wherein said control member of said actuating set is axially movable relative to said exhaust valve and squeeze against said exhaust valve axially or radially to adjust the opening of the adjustable air discharging hole of said control member.

9. The solenoid valve as claimed in claim 1, wherein said control member of said actuating set is rotatably fastened to said exhaust valve through a screw joint.

10. The solenoid valve as claimed in claim 1, wherein said exhaust valve of said actuating set has an exhaust hole in air communication with the axial through hole of said locating rod and an inside stop wall around said exhaust hole; said control member of said actuating set has a front squeeze portion, which is axially movable with said control member for stopping against the inside stop wall of said exhaust valve to adjust the flow rate of the air passing through said exhaust hole of said exhaust valve.
